(19) United States
(12) Patent Application Publication
(10) Pub. No.: US 2009/0277025 A1
(43) Pub. Date: Nov. 12, 2009

(54) MEASURING AND MARKING APPARATUS FOR VEHICLES

(76) Inventor: Dennis Torres, Honolulu, HI (US)

Correspondence Address: JAY M. SCHLOFF, 6960 Orchard Lake Road, Suite 315, West Bloomfield, MI, 48322, US

(21) Appl. No.: 12/437,119

(22) Filed: May 7, 2009

Related U.S. Application Data
(60) Provisional application No. 61/127,144, filed on May 9, 2008.

(51) Int. Cl. B43L 13/00

(52) U.S. Cl. 33/18.1

(57) ABSTRACT

An apparatus for measuring and marking a body portion of a vehicle for repairing the body portion of the vehicle. The apparatus includes a measuring component, and a sliding component. Further, the measuring component includes an elongated calibrating portion and a marking member. Furthermore, the elongated calibrating portion includes a proximal end portion, and a distal end portion opposite to the proximal end portion. The marking member is disposed on the proximal end portion of the elongated calibrating portion. Moreover, the sliding component is slidably attached to the elongated calibrating portion. The apparatus is capable of being aligned to the body portion of the vehicle such that the sliding component rests to an edge portion proximate to the body portion, and the measuring component extends over the body portion for measuring and marking the body portion when the apparatus is slid over the body portion.

### CROSS REFERENCE TO RELATED APPLICATIONS

The present disclosure claims priority under 35 United States Code, Section 119 on the U.S. Provisional Patent Application No. 61/127,144 filed on May 9, 2008 the disclosure of which is incorporated by reference.

### FIELD OF THE DISCLOSURE

The present disclosure generally relates to measuring and marking tools, and, more particularly, to an adjustable measuring and marking tool, to be used in relation to a damaged vehicle, for measuring distances and for placing marks at measured distance to repair the damaged vehicle.

### BACKGROUND OF THE DISCLOSURE

Vehicle repair tools, typically, include apparatuses for measuring and marking a body portion, specifically a damaged body portion, of a vehicle for repairing the vehicle. Repairing of such damaged body portion generally includes replacing or repairing metal and/or plastic parts. Prior to replacing or repairing of the metal and/or plastic parts of the damaged body portion, measuring and marking of the damaged body portion is required. Such measuring and marking allows an auto technician to easily locate the damaged body portion of the vehicle that needs repairing or replacement.

Generally, the apparatus for measuring the damaged body portion of the vehicle includes measuring tape. Typically, a measuring tape is a plastic strip or a metallic strip having linear measurement markings configured thereon. To repair or replace the metal and/or plastic parts in the damaged body portion, the measuring tape is first aligned against an undamaged body portion of the vehicle to get a measurement corresponding to the undamaged body portion. Further, the undamaged body portion is marked based on the measurement using a marking tool. Thereafter, the measuring tape is aligned against the damaged body portion of the vehicle to get a measurement corresponding to the damaged body portion, and then again marking the damaged body portion based on the measurement using the marking tool. The marked measurement corresponding to the undamaged body portion, and the marked measurement corresponding to the damaged body portion are then used to calculate a measurement to which the damaged body portion needs to be repaired or replaced. The metal and/or plastic parts of the damaged body portion is then repaired or replaced via various vehicle body tools available in the art.

Use of such apparatus and separate marking tool may preclude an accurate alignment of the apparatus against the body portion of the vehicle as the auto technician will require use of his/her one hand to hold such apparatus, and then, subsequently, use of his/her other hand to hold the marking tool for marking. Further, due to inaccurate alignment, the auto technician may not get accurate measurements. Moreover, the use of such apparatus and separate marking tool consumes time and may require considerable efforts from the auto technician.

Accordingly, there exists a need for accurate measurement of a body portion, specifically a damaged body portion, of a vehicle to repair such damaged body portion. Further, there exists a need for measuring and marking the body portion of the vehicle in manner that is easy to use and saves time.

### SUMMARY OF THE DISCLOSURE

In view of the foregoing disadvantages inherent in the prior art, the general purpose of the present disclosure is to provide an apparatus capable of measuring and marking a body portion, specifically a damaged body portion, of a vehicle, to include all advantages of the prior art, and to overcome the drawbacks inherent in the prior art.

An object of the present disclosure is to provide accurate measurements of a body portion, specifically a damaged body portion, of a vehicle to repair such damaged body portion.

Another object of the present disclosure is to measure and mark a body portion, specifically a damaged body portion, of a vehicle in a manner that is easy to use and saves time.

To achieve the above objects, in an aspect of the present disclosure, an apparatus for measuring and marking a body portion of a vehicle to repair the body portion is provided. The apparatus comprises a measuring component, and a sliding component slidably attached to the measuring component. The measuring component comprises an elongated calibrating portion and a marking member. The elongated calibrating portion has a proximal end portion, and a distal end portion opposite to the proximal end portion. Further, the marking member is disposed on the proximal end portion of the elongated calibrating portion. The marking member is capable of marking the body portion of the vehicle. Furthermore, the sliding component of the apparatus is slidably attached to the elongated calibrating portion for being adjusted on the elongated calibrating portion between the proximal end portion and the distal end portion. The apparatus is capable of being aligned to the body portion of the vehicle such that the sliding component rests to an edge portion proximate to the body portion of the vehicle and the measuring component extends over the body portion of the vehicle for measuring and marking the body portion when the apparatus is slid over the body portion of the vehicle, thereby enabling the body portion to be repaired based on the markings.

Resting the sliding component to the edge portion proximate to the body portion of the vehicle, and subsequently sliding the apparatus through the body portion of the vehicle enable accurate measuring and marking the body portion for repairing the body portion. Further, the apparatus is capable of measuring and marking the body portion of the vehicle in efficient time and is easy to use.

This together with the other aspects of the present disclosure, along with the various features of novelty that characterized the present disclosure, is pointed out with particularity in the claims annexed hereto and forms a part of the present disclosure. For a better understanding of the present disclosure, its operating advantages, and the specified object attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1A illustrates a perspective view of a bottom portion of an apparatus, in accordance with an exemplary embodiment of the present disclosure;

FIG. 1B illustrates a perspective view of a top portion of the apparatus, in accordance with an exemplary embodiment of the present disclosure; and

FIG. 2 illustrates the apparatus being utilized with respect to a vehicle, in accordance with an exemplary embodiment of the present disclosure.

Like reference numerals refer to like parts throughout the description of several views of the drawings.

### DETAILED DESCRIPTION OF THE DISCLOSURE

For a thorough understanding of the present disclosure, reference is to be made to the following detailed description, including the appended claims, in connection with the above-described drawings. Although the present disclosure is described in connection with exemplary embodiments, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the terms, “a” and “an” herein do not denote a limitation of quantity, but rather denote the presence of at least one of the referenced item

The present disclosure provides an apparatus for measuring and marking a body portion, such as a damaged body portion of a vehicle to repair the body portion. The apparatus provides accurate measurements to repair the damaged body portion of the vehicle. Moreover, the apparatus is capable of being utilized for measuring and marking in a time efficient and easy to use manner.

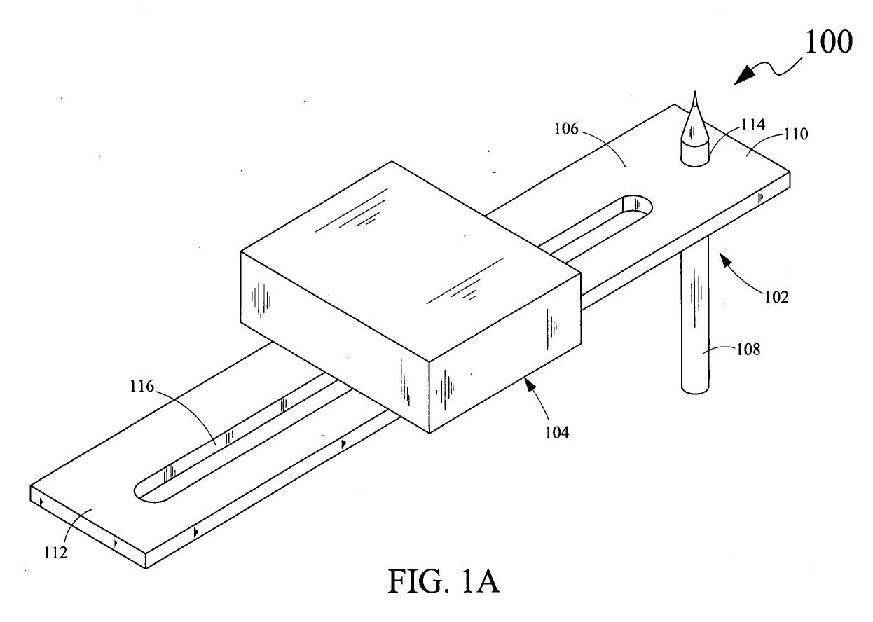

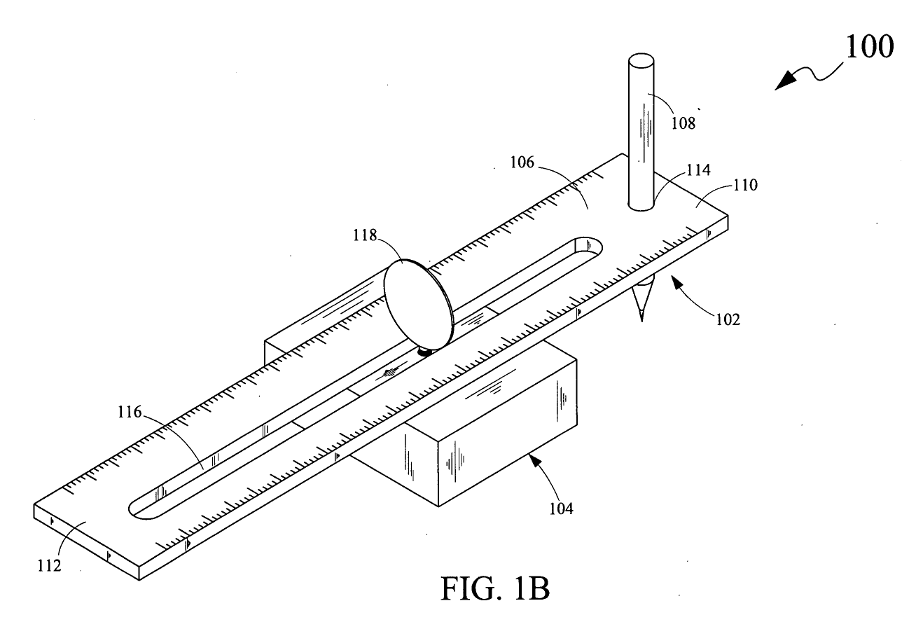

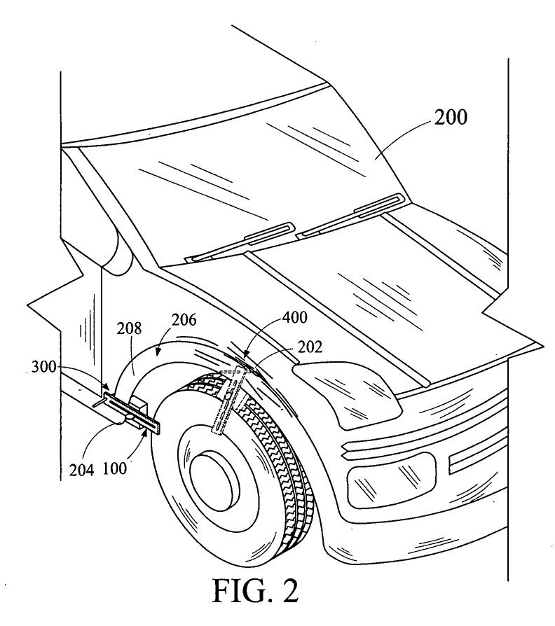

Referring now to FIG. 1A and FIG. 1B, wherein FIG. 1A illustrates a perspective view of a bottom portion of an apparatus 100, and FIG. 1B illustrates a perspective view of a top portion of the apparatus 100, in accordance with an exemplary embodiment of the present disclosure. The apparatus 100 includes a measuring component 102, and a sliding component 104 slidably attached to the measuring component 102. The apparatus 100 may be used with a vehicle (not shown). More particularly, the apparatus 100 may be aligned to a body portion of the vehicle such that the sliding component 104 rests to an edge portion proximate to the body portion of the vehicle, and the measuring component 102 extends over the body portion of the vehicle for measuring and marking the body portion of the vehicle. Further, based on the marking the body portion may be repaired. The utility of the apparatus 100 with regard to the vehicle will be described herein in conjunction with FIG. 2.

Referring to FIGS. 1A and 1B, the measuring component 102 includes an elongated calibrating portion 106, and a marking member 108. The elongated calibrating portion 106 includes a proximal end portion 110 and a distal end portion 112. Further, the elongated calibrating portion 106 includes measurement markings (as shown in FIG. 1B) configured thereon between the proximal end portion 110 and the distal end portion 112. The measurement markings may be in the form of metric units. Furthermore, the marking member 108 is disposed on the proximal end portion 110 of the elongated calibrating portion 106. More specifically, in one embodiment, the marking member 108 is engaged in an aperture 114 configured on the proximal end portion 110 of the elongated calibrating portion 106. It will be evident to those skilled in the art that though FIGS. 1A and 1B depict the aperture 114 for engaging the marking member 108, however, any other type of configuration may also be used to dispose the marking member 108 at the proximal end portion 110 of the elongated calibrating portion 106. The marking member 108 may be one of a pencil, a marker, and a pen.

Further, the sliding component 104 is slidably attached to the elongated calibrating portion 106 for being adjusted on the elongated calibrating portion 106 between the proximal end portion 110 and the distal end portion 112 of the elongated calibrating portion 106. More specifically, the elongated calibrating portion 106 includes an elongated aperture 116 extending between the proximal end portion 110 and the distal end portion 112 of the elongated calibrating portion 106 to slidably attach the sliding component 104 with the elongated calibrating portion 106. For establishing a slidable coupling between the sliding component 104 and the elongated calibrating portion 106, a fastening member 118 is provided. Specifically, the fastening member 118 passes through the elongated aperture 116 of the elongated calibrating portion 106 and is removably attached to the sliding component 104. The fastening member 118 is capable of being loosened for enabling the sliding component 104 to slidably move between the proximal end portion 110 and the distal end portion 112 of the elongated calibrating portion 106. Further, the fastening member 118 may be tightened to secure at a point on the elongated calibrating portion 106 between the proximal end portion 110 and the distal end portion 112. In this embodiment of the present disclosure, the fastening member 118 is shown as a threaded bolt fastener; however, it will be evident to a person skilled in the art to include any other type of fastening member available in the art.

The elongated calibrating portion 106 and the sliding component 104 are made of a plastic material. However, without departing from the scope of the present disclosure, the elongated calibrating portion 106 and the sliding component 104 may be made of any other material, such as metal, stainless steel, and the like.

Referring now to FIG. 2, the apparatus 100 being utilized with respect to a vehicle 200 is illustrated, in accordance with an embodiment of the present disclosure. Herein references of FIGS. 1A and 1B will be taken to describe the apparatus 100 being utilized with respect to the vehicle 200.

As shown in FIG. 2, a body portion 202 of the vehicle 200 is shown as damaged and need to be measured and marked for repairing purposes. Hereinafter, the body portion 202 will be referred to as damaged body portion 202. In order to ensure proper measurement of the damaged body portion 202, the sliding component 104 is aligned to an edge portion 204 proximate to a wheel opening molding 206 of the vehicle 200, at a first position 300 on the vehicle 200. At the first position 300, a body portion 208 of the vehicle 200 in undamaged. Hereinafter, the body portion 208 will be referred to as undamaged body portion 208. Further, the sliding component 104 is slid vertically through the elongated aperture 116 to adjust the sliding component 104 on the elongated calibrating portion 106 in order to align the sliding component 104 to the edge portion 204 proximate to the wheel opening molding 206 of the vehicle 200 at the first position 300 on the vehicle 200. Upon alignment of the sliding component 104 to the edge portion 204, the sliding component 104 is secured at a point by tightening the fastening member 118. Further, the sliding component 104 is aligned in a manner such that the measuring component 102 extends over the undamaged body portion 208 at the first position 300. Furthermore, upon alignment of the sliding component 104 to the edge portion 204, the apparatus 100 is then slid through the wheel opening molding 206 from the first position 300 to a second position 400, which is proximate to the damaged body portion 202.

Apparatus 100, on being slid from the first position 300 to the second position 400 of the vehicle 200, marks the undamaged body portion 208 and the damaged body portion 202 to indicate measurements of the damaged body portion 202 with respect to the undamaged body portion 208, which may be used to repair the damaged body portion 202 of the vehicle 200. For example, once the measurements of the damaged body portion 202, is done with respect to the undamaged body portion 208, a user, such as an auto technician may use a vehicle body tool, or the like, to repair or replace metal and/or plastic parts in the damaged body portion 202.

It will be evident to those skilled in the art that though FIG. 2 depicts the apparatus 100 for measuring and marking the damaged body portion 202 of the wheel opening molding 206 of the vehicle 200, the apparatus 100 may be used to measure and mark a damaged portion on any body portion of the vehicle 200.

The present disclosure provides an apparatus, such as the apparatus 100, which offers the following advantages. The apparatus is capable of providing accurate measurements of a damaged body portion with respect to an undamaged body portion of a vehicle that may be utilized to repair and/or replace the damaged body portion. The apparatus is capable of being utilized for measuring and marking the damaged body portion and the undamaged body portion of a vehicle in a manner that is easy to use and is time efficient.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. An apparatus for measuring and marking a body portion of a vehicle to repair the body portion, the apparatus comprising:
a measuring component, the measuring component comprising,
an elongated calibrating portion having a proximal end portion, and a distal end portion opposite to the proximal end portion, and
a marking member disposed on the proximal end portion of the elongated calibrating portion, wherein the marking member is capable of marking the body portion of the vehicle; and
a sliding component slidably attached to the elongated calibrating portion for being adjusted on the elongated calibrating portion between the proximal end portion and the distal end portion,
wherein the apparatus is capable of being aligned to the body portion of the vehicle such that the sliding component rests on an edge portion proximate to the body portion of the vehicle and the measuring component extends over the body portion of the vehicle for measuring and marking the body portion when the apparatus is slid over the body portion of the vehicle, thereby enabling the body portion to be repaired based on the markings.

2. The apparatus of claim 1, wherein the elongated calibrating portion comprises an elongated aperture extending between the proximal end portion and the distal end portion of the elongated calibrating portion to slidably attach the sliding component with the elongated calibrating portion for enabling slidable adjustment of the sliding component on the elongated calibrating portion.

3. The apparatus of claim 1, further comprising a fastening member to attach the sliding component to the elongated calibrating portion.

4. The apparatus of claim 3, wherein the fastening member is a threaded bolt fastener.

5. The apparatus of claim 1, wherein the marking member is disposed in an aperture configured on the proximal end portion of the elongated calibrating portion.

6. The apparatus of claim 1, wherein the marking member is one of a pencil, a marker, and a pen.

7. The apparatus of claim 1, wherein the elongated calibrating portion is made of a plastic material.

8. The apparatus of claim 1, wherein the sliding component is made of a plastic material.
